(19) United States
(12) Patent Application Publication
(10) Pub. No.: US 2020/0234149 A1
(43) Pub. Date: Jul. 23, 2020

(54) INFORMATION PROCESSING DEVICE, INFORMATION PROCESSING SYSTEM, INFORMATION PROCESSING METHOD, AND STORAGE MEDIUM

(71) Applicant: NEC Corporation, Minato-ku, Tokyo (JP)

(72) Inventor: Yoshiyuki GOTO, Tokyo (JP)

(73) Assignee: NEC Corporation, Minato-ku, Tokyo (JP)

(21) Appl. No.: 16/647,575

(22) PCT Filed: Sep. 14, 2018
(86) PCT No.: PCT/JP2018/034287

§ 371 Date: Mar. 16, 2020

(30) Foreign Application Priority Data
Sep. 20, 2017 (JP) 2017-179960

(51) Int. Cl. G06N 5/02; G06Q 30/02; G06N 20/00

(52) U.S. Cl. CPC G06N 5/02; G06N 20/00; G06Q 30/0202

(57) ABSTRACT

An information processing device according to an example embodiment includes: a calculation unit that calculates a feature amount between multiple pieces of attribute information in analysis data including the multiple pieces of attribute information; and a prediction unit that predicts, from the feature amount, processing time when an analysis task for the analysis data is performed by using a predetermined resource.

### TECHNICAL FIELD

The present invention relates to an information processing device, an information processing system, an information processing method, and a storage medium.

### BACKGROUND ART

As current analysis technologies, big data analysis such as a product demand prediction in retail businesses is known. In big data analysis, it is necessary to analyze a correlation between a large number of attributes such as the basket problem, for example, and thus the process load becomes significantly higher. A load distribution process using a resource on a cloud is widely employed in order to perform an analysis process in limited time.

Patent Literature 1 discloses a resource sharing system that can share a surplus resource between a plurality of services (applications). In the resource sharing method, a load prediction is performed by using the past operation history for each service and a surplus resource is allocated to each service in accordance with the prediction result.

### CITATION LIST

### Patent Literature

PTL 1: Japanese Patent Application Laid-Open No. 2005-141605

### SUMMARY OF INVENTION

### Technical Problem

When an analysis process is performed in a cloud environment, a process load such as time required for a process or a required resource amount is not regular every time and may significantly vary. Thus, when prediction is performed by using the past operation history as Patent Literature 1, it is difficult to accurately predict a process load.

The present invention has been made in view of the above problem and intends to provide an information processing device, an information processing method, and a storage medium that can accurately predict a process load.

### Solution to Problem

According to one example aspect of the present invention, provided is an information processing device including: a calculation unit that calculates a feature amount between multiple pieces of attribute information in analysis data including the multiple pieces of attribute information; and a prediction unit that predicts, from the feature amount, processing time when an analysis task for the analysis data is performed by using a predetermined resource.

According to another example aspect of the present invention, provided is an information processing method including steps of: calculating a feature amount between multiple pieces of attribute information in analysis data including the multiple pieces of attribute information; and predicting, from the feature amount, processing time when an analysis task for the analysis data is performed by using a predetermined resource.

According to another example aspect of the present invention, provided is a storage medium storing a program that causes a computer to perform steps of: calculating a feature amount between multiple pieces of attribute information in analysis data including the multiple pieces of attribute information; and predicting, from the feature amount, processing time when an analysis task for the analysis data is performed by using a predetermined resource.

### Advantageous Effects of Invention

According to the present invention, an information processing device, an information processing method, and a storage medium that can accurately predict a process load are provided.

### BRIEF DESCRIPTION OF DRAWINGS

FIG. 1 is a block diagram illustrating the whole configuration of an analysis system according to a first example embodiment.

FIG. 2 is a block diagram illustrating a hardware configuration of a resource optimizing device according to the first example embodiment.

FIG. 3 is an example of sales data according to the first example embodiment.

FIG. 4 is an example of an analysis task table according to the first example embodiment.

FIG. 5 is a flowchart illustrating an operation of the analysis system according to the first example embodiment.

FIG. 6 is an example of a past process result according to the first example embodiment.

FIG. 7 is a flowchart illustrating an operation of the resource optimizing device according to the first example embodiment.

FIG. 8 is an example of a processing time coefficient according to the first example embodiment.

FIG. 9 is an example of a current process result according to the first example embodiment.

FIG. 10 is a schematic configuration diagram of a resource optimizing device according to a second example embodiment.

### DESCRIPTION OF EMBODIMENTS

### First Example Embodiment

FIG. 1 is a block diagram illustrating the whole configuration of an analysis system according to a first example embodiment. The analysis system according to the present example embodiment is an information processing system for performing a so-called big data analysis. An example in which a large amount of analysis processing is performed by a batch process every day by using a resource on a cloud will be described below. The analysis system has an analysis client 100, a que 110, worker instances 120, an analysis result Database (DB) 130, and a resource optimizing device 140. The resource optimizing device 140 is an example embodiment of the information processing device according to the present invention.

The analysis client 100 is a terminal device such as a personal computer and is connected to shop DBs 150 via a network (not illustrated), for example. The shop DB 150 is a database provided on a shop basis, and the number of the shop DBs 150 is not limited. The shop DB 150 is updated every day after the shop is closed, for example. The analysis client 100 performs a batch process for data analysis at predetermined time every day.

In a batch process, first, the analysis client 100 collects sales data from one or a plurality of shop DBs 150. In the sales data, sales information on each product that is sold at the shop is included. The analysis client 100 generates a plurality of analysis tasks used for analyzing the collected sales data and registers these analysis tasks in the que 110.

The que 110 is a storage device that is connected to the analysis client 100 and temporarily stores the analysis tasks from the analysis client 100. For example, the que 110 is connected to a cloud environment via a Virtual Private Network (VPN), and sequentially outputs the analysis tasks in the First In First out (FIFO) scheme to any of the worker instances 120. Thereby, the analysis tasks are sequentially performed by the worker instances 120. The que 110 may be integrally provided with the analysis client 100 or may be provided on a cloud.

The worker instance 120 is a virtual machine (virtual instance) arranged on a cloud and virtually has a central processing unit (CPU), a memory, a storage, or the like. The worker instance 120 performs an analysis task on sales data and stores an analysis result obtained from the analysis in the analysis result DB 130. The analysis task is a task related to machine learning, for example, and is a process for building a prediction model based on learning data extracted from the sales data. The analysis result includes processing time required for the process of the analysis task or the like in addition to the built prediction model.

The analysis result DB 130 is a large-capacity storage device such as a hard disk, for example, and is connected to a cloud environment via a VPN as with the que 110. In the analysis result DB 130, an analysis result obtained from the worker instance 120, data calculated by the resource optimizing device 140, or the like are stored. The data stored in the analysis result DB 130 may be obtained by the analysis client 100. The analysis result DB 130 may be integrally provided with the analysis client 100.

The resource optimizing device 140 has a feature amount calculation unit 141, a performance calculation unit 142, a process load prediction unit 143, and an instance control unit 144. The feature amount calculation unit 141 calculates a feature amount related to sales data based on an analysis task registered in the que 110. The feature amount may be, for example, covariance, a correlation coefficient, or the like between pieces of attribute information included in the sales data. The calculated feature amount is stored in the analysis result DB 130.

The performance calculation unit 142 calculates a processing time coefficient and a performance coefficient on an analysis task basis as a parameter used when predicting a process load based on the feature amount obtained from the analysis result DB 130 and the past processing time. The processing time coefficient represents a relationship between the processing time and the feature amount actually obtained in the past batch process. When covariance is used as a feature amount, the processing time coefficient is calculated from the following Equation (1).

$$\begin{matrix}[ Math . 1 ] & \\ PROCESSING TIME {COEFFICIENT}_{i} = \frac{PROCESSING {TIME}_{i} - AVERAGE PROCESSING TIME}{{COVARIANCE}_{i} - AVERAGE COVARIANCE} & ( 1 )\end{matrix}$$

Herein, the index i denotes a date of performing analysis. The average processing time and the average covariance represent an average of processing time and an average of covariance in a predetermined period (for example, the last month) respectively.

Further, the performance coefficient represents process performance of the current worker instance 120 in comparison with the past and is estimated by comparing processing time obtained by the past batch process (that is, until the day before) with processing time obtained so far by the current (that is, today) batch process. Specifically, the performance coefficient is calculated from the following Equation (2).

$$\begin{matrix}[ Math . 2 ] & \\ PERFORMANCE COEFFICIENT = \frac{1}{n} {\sum }_{i = 1}^{n} \frac{\begin{matrix}CURRENT PROCESSING TIME \\ OF PERFORMED {TASK}_{i}\end{matrix}}{AVERAGE PROCESSING TIME OF PAST {TASK}_{i}} & ( 2 )\end{matrix}$$

Herein, the value n denotes the number of analysis tasks generated by the batch process, and the performed task represents the analysis task that has already been performed by the current batch process out of n analysis tasks.

The process load prediction unit 143 obtains a list of unperformed analysis tasks (remaining task) remaining in the que 110 from the que 110 and obtains a processing time coefficient and a performance coefficient on an analysis task basis from the performance calculation unit 142. Further, the process load prediction unit 143 obtains the past average covariance and the current covariance on an analysis task basis from the analysis result DB 130 via the performance calculation unit 142 or directly. The process load prediction unit 143 calculates predicted processing time of each remaining task and total predicted processing time (total predicted processing time) of all the remaining tasks included in the list by using the following Equations (3) and (4).

$$[ Math . 3 ]$$

$$( 3 )$$

$$PREDICTED PROCESSING TIME OF REMAINING {TASK}_{i} = \{ AVERAGE PROCESSING TIME OF REMAINING {TASK}_{i} + ( COVARIANCE - AVERAGE COVARIANCE ) \times PROCESSING TIME COEFFICIENT \} \times PERFORMANCE COEFFICIENT \\ [ Math . 4 ]$$

$$( 4 )$$

$$PREDICTED TOTAL PROCESSING TIME = {\sum }_{i = 1}^{n} PREDICTED PROCESSING TIME OF REMAINING {TASK}_{i}$$

Herein, the value n denotes the number of remaining tasks.

Moreover, the process load prediction unit 143 calculates the number of worker instances 120 (required instance quantity) required for performing all the remaining tasks by the end time of the batch process by using the following Equation (5).

$$\begin{matrix}[ Math . 5 ] & \\ REQUIRED INSTANCE QUANTITY = \frac{TOTAL PREDICTED PROCESSING TIME}{END TIME - CURRENT TIME} & ( 5 )\end{matrix}$$

In Equation (5), the required instance quantity is rounded up to an integer.

The instance control unit 144 adjusts the number of worker instances 120 in accordance with the required instance quantity input from the process load prediction unit 143. For example, the instance control unit 144 can increase or decrease the number of worker instances 120 by transmitting an instance creation request and an instance deletion request to a host server on a cloud that manages the worker instance 120.

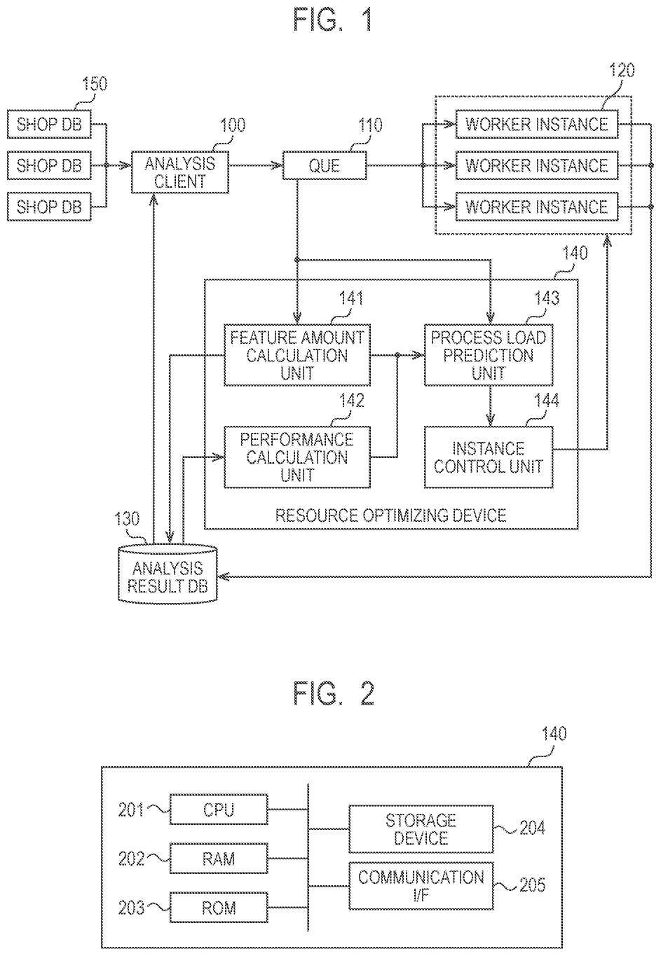

FIG. 2 is a block diagram illustrating a hardware configuration of a resource optimizing device according to the present example embodiment. The resource optimizing device 140 has a CPU 201, a random access memory (RAM) 202, a read only memory (ROM) 203, a storage device 204, and a communication interface (I/F) 205.

The CPU 201 has a function of performing a predetermined operation in accordance with a program stored in the ROM 203 or the storage device 204 and controlling each component of the resource optimizing device 140. Further, the CPU 201 performs a program to realize the function of the feature amount calculation unit 141, the performance calculation unit 142, the process load prediction unit 143, or the instance control unit 144.

The RAM 202 is formed of a volatile memory and provides a memory area necessary for the operation of the CPU 201. The ROM 203 is formed of a nonvolatile memory and stores such as a program or data necessary for the operation of the resource optimizing device 140. The storage device 204 is a flash memory, a solid state drive (SSD), a hard disk drive (HDD), or the like, for example.

The communication I/F 205 is a network interface based on the specification such as Ethernet (registered trademark), Wi-Fi (registered trademark), or the like, which is a module used for communicating with an external device such as the que 110, the worker instance 120, or the analysis result DB 130.

Note that the hardware configuration illustrated in FIG. 2 is an example, and devices other than the devices described above may be added, or some of the devices may not be provided. For example, some functions may be provided by another device via a network, and the functions forming the present example embodiment may be distributed and implemented in a plurality of devices.

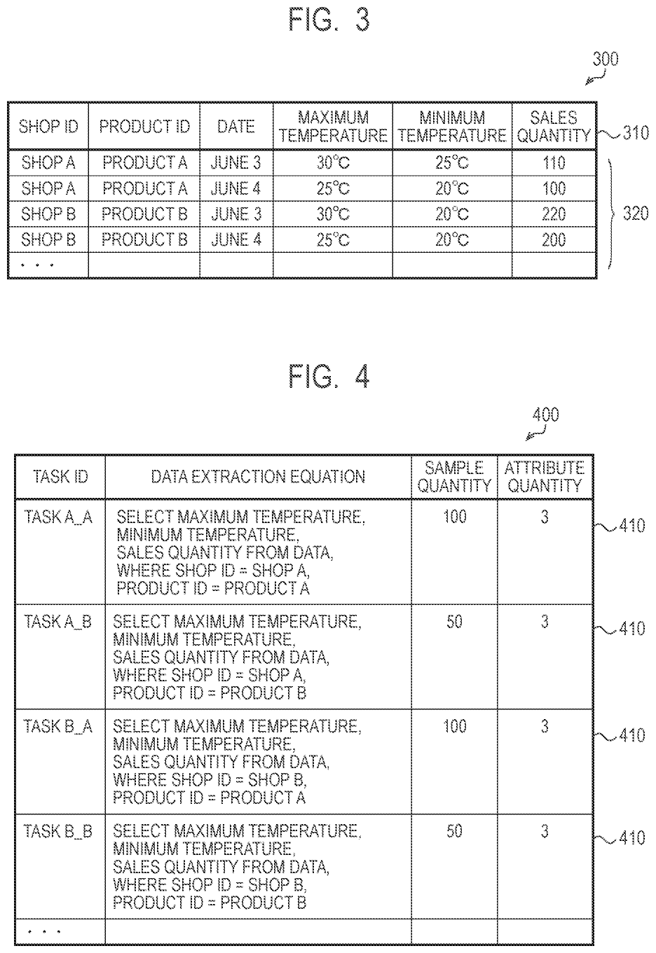

FIG. 3 is an example of sales data according to the present example embodiment. The sales data 300 is analysis data to be analyzed and includes attribute information 320 on a plurality of attributes 310. The attribute 310 may be, for example, a shop ID, a product ID, a date, the maximum temperature, the minimum temperature, a sales quantity, or the like. As the attribute 310, a day of week, an amount of precipitation, a sunshine duration, a snow accumulation, a humidity, a cloud amount, an atmospheric pressure, a region, or the like may be used.

The shop ID is a name or an identification number of the shop where a product is sold. The product ID is a name or an identification number of a product to be sold. The date is a sale date of a product, and the maximum temperature and the minimum temperature are observation values on the sale date. The sales quantity is the number of products sold on the sale date. Note that, in the example of FIG. 3, while sales data of different dates are summarized within one table, when the batch process is performed every day such as the present example embodiment, the sales data 300 for each date may be created.

FIG. 4 is an example of an analysis task table according to the present example embodiment. In an analysis task table 400, a plurality of analysis tasks 410 are defined as a record. The number of analysis tasks 410 may be around 10,000, for example. Each analysis task 410 has a field of a task ID, a data extraction equation, a sample quantity, or an attribute quantity.

The task ID is a name or an identification number of the analysis task 410. The data extraction equation is a query used for extracting data (record) to be analyzed in the sales data 300 and is described by structure query language (SQL) or the like. The data extraction equations of respective analysis tasks 40 are the same, and the same attribute data is extracted on a shop ID basis and a product ID basis. The samples quantity is the number of records extracted by the data extraction equation, and the attribute quantity is the number of attributes 310 included in the record extracted by the data extraction equation. For example, the attribute quantity may be greater than or equal to 10 or may be different on an analysis task 410 basis.

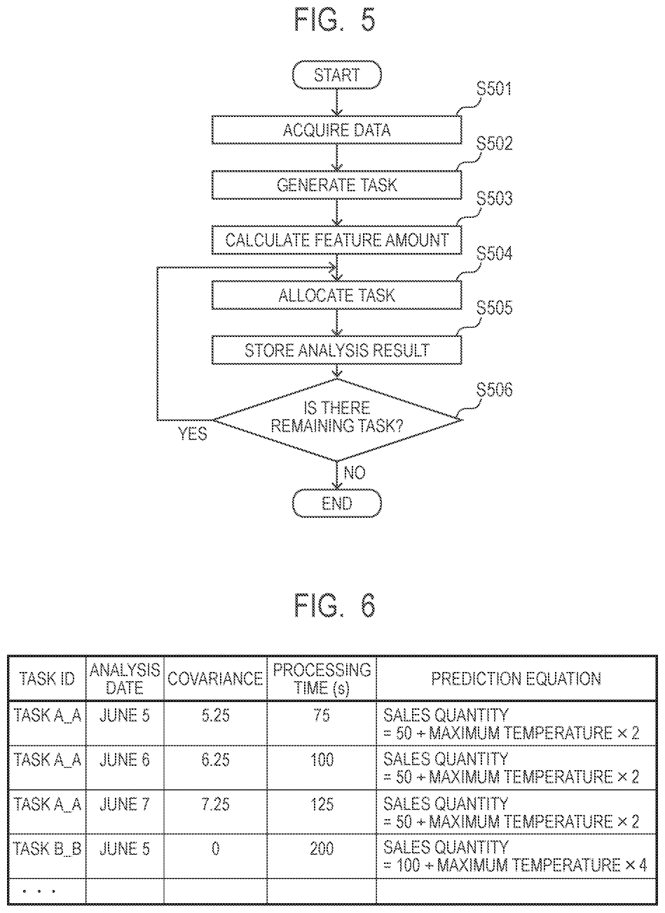

FIG. 5 is a flowchart illustrating the operation of the analysis system according to the present example embodiment. The analysis system starts a batch process at the start time every day. For example, the start time is ten o'clock in the afternoon after the shop is closed. First, the analysis client 100 obtains sales data (see FIG. 3) from each shop DB 150 (step S501). For example, when today is June 8, the sales data on June 8 is obtained.

Next, the analysis client 100 generates a plurality of analysis tasks based on the obtained sales data (step S502). The analysis task is defined in the analysis task table (see FIG. 4), and typically, the same analysis task is generated every day. The generated analysis task is transmitted from the analysis client 100 to the que 110.

The feature amount calculation unit 141 obtains information related to the analysis task from the que 110 and calculates, on an analysis task basis, the feature amount between attributes of data to be analyzed (step S503). For example, in the sales data 300 illustrated in FIG. 3, the covariance of the maximum temperature and the minimum temperature are calculated as a feature amount. The calculated covariance is included in the analysis result and then stored in the analysis result DB 130.

The que 110 temporarily stores the analysis task from the analysis client 100 and allocates analysis task one by one to the worker instance 120 on which an analysis task has been performed or the worker instance 120 which is newly added (step S504). The number of worker instances 120 is appropriately adjusted by the resource optimizing device 140 so that all the analysis tasks are completed by the end time (for example, six o'clock in the morning on the next day).

The worker instance 120 performs the allocated analysis tasks and stores the analysis result of the sales data in the analysis result DB 130 (step S505). As illustrated in FIG. 6, the analysis result may include a task ID, an analysis date, a covariation, processing time, and a prediction equation. Note that, in an example of FIG. 6, while prediction equations of June 5 to June 7 are the same, this is a mere example and the prediction equation may change in accordance with a date.

The task ID is a name or an identification number of the analysis task performed by the worker instance 120. The analysis date is a date on which the analysis task is performed. The covariance is a feature amount calculated from the maximum temperature and the minimum temperature in the sales data. The processing time is the time required for performing the analysis task and is expressed by seconds, for example. The prediction equation is a prediction model that represents the relationship between attributes of sales data and is obtained by performing an analysis task. The prediction equation may be a multiple-regression equation having the plurality of attributes 310 as variables or the like in addition to a single regression equation illustrated in FIG. 6.

Note that, in the present example embodiment, since covariance is calculated in the performance process of the analysis task by the worker instance 120, a feature amount calculation process by the feature amount calculation unit 141 (step S503) can be omitted.

Next, the que 110 determines whether or not there is a remaining task (step S506). That is, the que 110 determines whether or not an unperformed analysis task that is not allocated to the worker instance 120 in the plurality of analysis tasks received from the analysis client 100 remains in the que 110.

If there is a remaining task (step S506: YES), the que 110 returns to step S504 to allocate the remaining task to the worker instance 120. If there is no remaining task (step S506: NO), the analysis system ends the batch process.

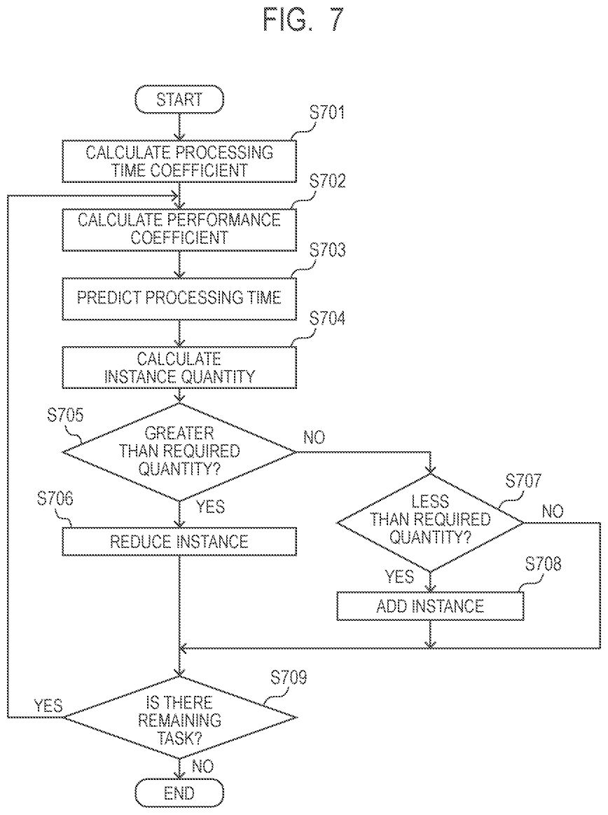

FIG. 7 is a flowchart illustrating the operation of the resource optimizing device according to the present example embodiment. When the batch process starts, the feature amount calculation unit 141 obtains the past analysis result from the analysis result DB 130 as illustrated in FIG. 6. For example, when today is June 8, an analysis result during the last three days (that is, from June 5 to June 7) is obtained. The period of the analysis result obtained here is not limited and may be a week, a month, three months, six months, or a year, or the like, for example.

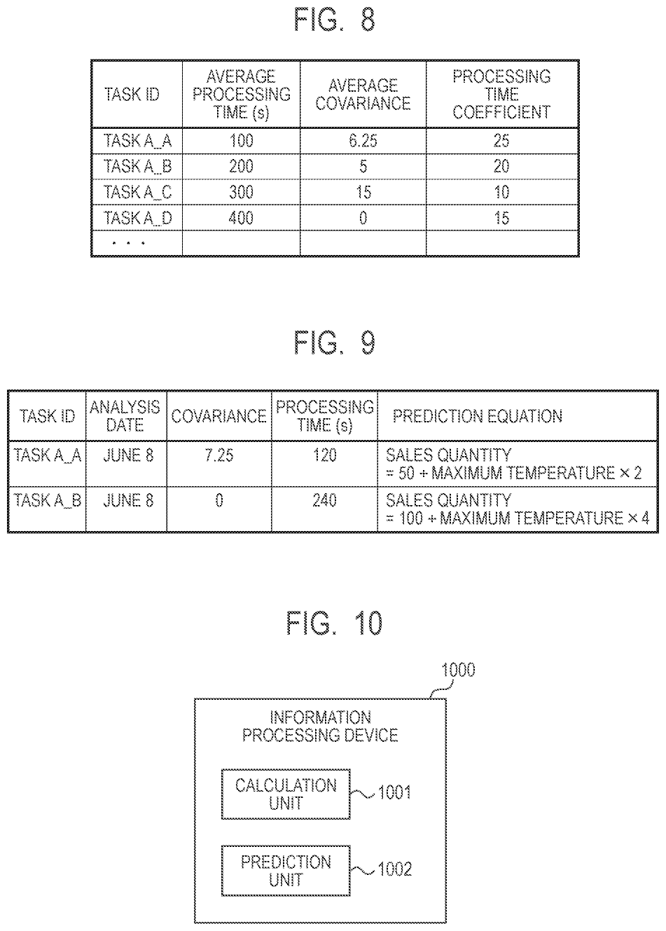

The feature amount calculation unit 141 calculates a processing time coefficient by using Equation (1) described above based on the past analysis result (step S701). An example of the calculated processing time coefficient is illustrated in FIG. 8. For example, when the average from June 5 to June 7 in the analysis result of FIG. 6 is taken, the average processing time of task A_A is calculated as (75+100+125)/3=100 [seconds], and the average covariance of task A_A is calculated as (5.25+6.25+7.25)/3=6.25. Therefore, the processing time coefficient of task A_A is calculated as (125-100)/(7.25-6.25)=25 by using the covariance and processing time of the previous day (June 7). The processing time coefficients of other analysis tasks are calculated in the same manner.

The performance calculation unit 142 accesses the analysis result DB 130 on a certain time basis and, when the analysis result related to the current batch process is stored, then obtains the analysis results from the analysis result DB 130. In other words, in the today's batch process, the analysis result of the analysis task that has already been performed so far is obtained. The performance calculation unit 142 calculates a performance coefficient by using Equation (2) described above based on the obtained processing time and the average processing time calculated in the feature amount calculation unit 141 (step S702). That is, the ratio between the current processing time and the past average processing time is calculated on a performed analysis task basis, and the average value of the ratios for all the performed analysis tasks is determined as a performance coefficient.

For example, it is assumed that an analysis result has been obtained in a today's (June 8) batch process as illustrated in FIG. 9. That is, in a plurality of analysis tasks performed by the batch process, task A_A and task A_B have been performed. In this case, the performance coefficient is calculated as below.

$$[ Math . 6 ]$$

$$PERFORMANCE COEFFICIENT = \frac{1}{2} ( \frac{CURRENT PROCESSING TIME OF TASK A\_A}{AVERAGE PROCESSING TIME OF TASK A\_A} + \frac{CURRENT PROCESSING TIME OF TASK A\_B}{AVERAGE PROCESSING TIME OF TASK A\_B } ) = \frac{1}{2} ( \frac{120}{100} + \frac{240}{200} ) = 1.2$$

The process load prediction unit 143 predicts the total processing time required for performing remaining tasks based on the average processing time and the performance coefficient for each analysis task that are obtained for the performance calculation unit 142 and the covariance related to the remaining tasks obtained for the feature amount calculation unit 141 (step S703). The total processing time is predicted by Equations (3) and (4) described above.

For example, to simplify the illustration, it is assumed that the remaining tasks include only task A_C and task A_D, and the covariance calculated by the feature amount calculation unit 141 for these analysis tasks are all 10. In this case, the expected processing time of task A_C is calculated as {300+(10−15)×10}×1.2=300 [seconds], and the expected processing time of task A_D is calculated as {400+(10−10)×15}×1.2=480 [seconds]. Therefore, the total expected processing time is 300+480=780 [seconds].

Next, the process load prediction unit 143 calculates the required instance quantity by using Equation (5) described above based on the calculated total predicted processing time and the current time (step S704). For example, when time from the current time to the end time is 100 seconds, and the total predicted processing time is 780 seconds as described above, the required instance quantity will be 8, which is the integer rounded up from the result 780/100=7.8.

The instance control unit 144 compares the number of currently arranged worker instances 120 (current quantity) with the required instance quantity obtained from the process load prediction unit 143 (required quantity) (steps S705, S707). If the current quantity is greater than the required quantity (step S705: YES), that is, the number of worker instances 120 is excessive, the instance control unit 144 reduces the number of worker instances 120 in accordance with the required quantity (step S706).

If the current quantity is less than the required quantity (step S705: NO and step S707: YES), that is, the number of worker instances 120 is insufficient, the instance control unit 144 adds the worker instance 120 in accordance with the required quantity (step S708). If the current quantity and the required quantity are the same (step S705: NO and step S707: NO), the instance control unit 144 does not adjust the number of worker instances 120.

The process load prediction unit 143 determines whether or not there is a remaining task in the que 110 based on the remaining task list obtained from the que 110 (step S709). If there is a remaining task (step S709: YES), the processes subsequent to the performance coefficient calculation process (step S702) are repeated. If there is no remaining task (step S709: NO), the resource optimizing device 140 ends the process.

In such a way, in the present invention, the feature amount for the attribute included in the analysis data is calculated, and the processing time is predicted by the feature amount based on the relationship between the feature amount and the actual processing time. In general, a correlation between attributes of analysis data is a non-deterministic polynomial time (NP) problem in machine learning, and it is difficult to predict the process load of analysis from a data amount. In contrast, according to the present example embodiment, it is possible to accurately predict a process load by using the feature amount.

Further, in the present example embodiment, since the number of attributes is much less than the data number of analysis data, a calculation amount used for calculating the feature amount is reduced, and the prediction of a process load can be effectively performed. Moreover, the analysis system is configured to dynamically optimize a resource based on a prediction result of a process load, and thereby an analysis process can be completed with the minimum resource amount in limited time.

### Second Example Embodiment

FIG. 10 is a schematic configuration diagram of an information processing device according to a second example embodiment. An information processing device 1000 has a calculation unit 1001 and a prediction unit 1002. The calculation unit 1001 calculates a feature amount between multiple pieces of attribute information in the analysis data including the multiple pieces of the attribute information. The prediction unit 1002 predicts, from the feature amount, processing time when an analysis task for the analysis data is performed by using a predetermined resource.

### Modified Example Embodiment

The present invention can be appropriately changed within the scope not departing from the spirit of the present invention without being limited to the example embodiments described above. For example, the equation that expresses the relationship between a feature amount and processing time is not limited to Equation (1) described above. The relationship can also be expressed as an equation in which processing time is inversely proportional to absolute value of the correlation coefficient between attributes. Further, multiple types of covariance between different attributes can be combined and used as a feature amount.

Further, while a batch process is performed every day in the example embodiments described above, the batch process may be any process that is performed periodically. That is, any process may be employed as long as the same analysis task is repeatedly performed on analysis data of the same format obtained historically.

Further, in the example embodiment described above, the worker instances 120 have the same performance, and the number of worker instances 120 is controlled in accordance with the predicted processing time. Alternatively, the number of worker instances 120 may be fixed, and the performance of CPU, the memory size, the storage size, or the like of the worker instances 120 may be adjusted.

The scope of each of the example embodiments further includes a processing method that stores, in a storage medium, a program (more specifically, a program that causes a computer to perform a process illustrated in FIG. 5 or FIG. 7) that causes the configuration of each of the example embodiments to operate so as to implement the function of each of the example embodiments described above, reads the program stored in the storage medium as a code, and performs the program in a computer. That is, the scope of each of the example embodiments also includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

An information processing device comprising:

a calculation unit that calculates a feature amount between multiple pieces of attribute information in analysis data including the multiple pieces of attribute information; and

a prediction unit that predicts, from the feature amount, processing time when an analysis task for the analysis data is performed by using a predetermined resource.

(Supplementary Note 2)

The information processing device according to supplementary note 1,

wherein the analysis data is updated and the analysis task is performed on a predetermined cycle basis, and

wherein the prediction unit predicts the processing time in a current cycle based on the relationship between the feature amount and the processing time in a past cycle.

(Supplementary Note 3)

The information processing device according to supplementary note 2,

wherein a plurality of different analysis tasks are sequentially performed on the cycle basis, and wherein the prediction unit predicts the processing time of an unperformed analysis task of the plurality of analysis tasks based on the processing time of a performed analysis task of the plurality of analysis tasks in the current cycle.

(Supplementary Note 4)

The information processing device according to supplementary note 3,

wherein the feature amount is covariance, and
wherein the processing time is proportional to covariance.

(Supplementary Note 5)

The information processing device according to any one of supplementary notes 1 to 4, wherein the analysis task is machine learning for building a prediction model using the attribute information.

(Supplementary Note 6)

The information processing device according to any one of supplementary notes 1 to 5 further comprising a control unit that controls an amount of resource used for performing the analysis task based on the predicted processing time.

(Supplementary Note 7)

The information processing device according to supplementary note 6, wherein the resource is a virtual instance arranged on a network.

(Supplementary Note 8)

An information processing system comprising:

the information processing device according to supplementary note 6 or 7; and

a terminal device that obtains the analysis data and performs the analysis task by using the resource.

(Supplementary Note 9)

An information processing method comprising steps of:

calculating a feature amount between multiple pieces of attribute information in analysis data including the multiple pieces of attribute information; and

predicting, from the feature amount, processing time when an analysis task for the analysis data is performed by using a predetermined resource.

(Supplementary Note 10)

A storage medium storing a program that causes a computer to perform steps of:

calculating a feature amount between multiple pieces of attribute information in analysis data including the multiple pieces of attribute information; and

predicting, from the feature amount, processing time when an analysis task for the analysis data is performed by using a predetermined resource.

This application is based upon and claims the benefit of priority from Japanese Patent Application No. 2017-179960, filed on Sep. 20, 2017, the disclosure of which is incorporated herein in its entirety by reference.

What is claimed is:

1. An information processing device comprising:
a calculation unit that calculates a feature amount between multiple pieces of attribute information in analysis data including the multiple pieces of attribute information; and
a prediction unit that predicts, from the feature amount, processing time when an analysis task for the analysis data is performed by using a predetermined resource.

2. The information processing device according to claim 1,
wherein the analysis data is updated and the analysis task is performed on a predetermined cycle basis, and
wherein the prediction unit predicts the processing time in a current cycle based on the relationship between the feature amount and the processing time in a past cycle.

3. The information processing device according to claim 2,
wherein a plurality of different analysis tasks are sequentially performed on the cycle basis, and
wherein the prediction unit predicts the processing time of an unperformed analysis task of the plurality of analysis tasks based on the processing time of a performed analysis task of the plurality of analysis tasks in the current cycle.

4. The information processing device according to claim 3,
wherein the feature amount is covariance, and
wherein the processing time is proportional to covariance.

5. The information processing device according to claim 1, wherein the analysis task is machine learning for building a prediction model using the attribute information.

6. The information processing device according to claim 1, further comprising a control unit that controls an amount of resource used for performing the analysis task based on the predicted processing time.

7. The information processing device according to claim 6, wherein the resource is a virtual instance arranged on a network.

8. An information processing system comprising:
the information processing device according to claim 6; and
a terminal device that obtains the analysis data and performs the analysis task by using the resource.

9. An information processing method comprising steps of:
calculating a feature amount between multiple pieces of attribute information in analysis data including the multiple pieces of attribute information; and
predicting, from the feature amount, processing time when an analysis task for the analysis data is performed by using a predetermined resource.

10. A non-transitory storage medium storing a program that causes a computer to perform steps of:
calculating a feature amount between multiple pieces of attribute information in analysis data including the multiple pieces of attribute information; and
predicting, from the feature amount, processing time when an analysis task for the analysis data is performed by using a predetermined resource.
